(19) United States
(12) Patent Application Publication
(10) Pub. No.: US 2026/0203227 A1
(43) Pub. Date: Jul. 16, 2026

(54) Method and Apparatus for Controlling Storage Resources in Storage Node, and Storage Node

(71) Applicant: SUZHOU METABRAIN INTELLIGENT TECHNOLOGY CO., LTD., Suzhou, Jiangsu (CN)

(72) Inventors: Hongsheng HOU, Suzhou, Jiangsu (CN); Wenzhi LIU, Suzhou, Jiangsu (CN); Zhikui LIU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/134,665

(22) PCT Filed: Mar. 13, 2023
(86) PCT No.: PCT/CN2023/081163

§ 371 Date: May 30, 2025

(30) Foreign Application Priority Data
Nov. 30, 2022 (CN) 202211519717.8

(51) Int. Cl. G06F 12/0891

(52) U.S. Cl. CPC G06F 12/0891

(57) ABSTRACT

Provided are a method and apparatus for controlling storage resources in a storage node, and a storage node. The method includes: in a process of deleting a cache partition in a storage node, detecting an operation state of a currently executed current operation process; in cases where it is detected that the operation state indicates that the currently executed operation process fails to be completed, detecting a target scenario which causes the currently executed operation process to fail to be completed; restoring the currently executed operation process to a target operation process according to the target scenario; and executing the target operation process, wherein the target operation process is used for continuing to realize the deletion of the cache partition starting from a target partition state of the cache partition which is indicated by the target scenario.

### CROSS-REFERENCE TO RELATED APPLICATION

The present application claims priority to Chinese Patent Application no. 202211519717.8, to the China National Intellectual Property Administration on 30 Nov. 2022 and entitled “Method and Apparatus for Controlling Storage Resources in Storage Node, and Storage Node”, which is incorporated herein by reference in its entirety.

### TECHNICAL FIELD

Embodiments of the present application relate to the field of computers, and in particular, to a method and apparatus for controlling storage resources in a storage node, and a storage node.

### BACKGROUND

A storage node (for example, a Solid State Disk (SSD)) may allocate a cache partition to another device for use, and when the cache partition is used up or is not used any more, the allocated cache partition needs to be reclaimed, which is referred to as a process of deleting the cache partition. In this process, a series of operation processes may be performed to delete the cache partition, or cache partitions with different functions may perform different operation processes when being deleted. In the current schemes for deleting cache partitions, if errors or failures occur during the execution of these operation processes, the cache partitions may not be able to be deleted properly, thereby preventing the cache partition from being reclaimed and reused, which also results in resource waste.

For the problem in the related art that the success ratio is low when the cache partition in the storage node is deleted, no effective solution has been proposed.

### SUMMARY

Embodiments of the present application provide a method and apparatus for controlling storage resources in a storage node, and a storage node, so as to at least solve the problem in the related art that the success rate is relatively low when a cache partition in a storage node is

According to one embodiment of the present application, provided is a method for controlling storage resources in a storage node, including:
in a process of deleting a cache partition in a storage node, detecting an operation state of a currently executed current operation process, wherein the deletion of the cache partition includes one or more operation processes, and the one or more operation processes include the currently executed operation process;
in cases where it is detected that the operation state indicates that the currently executed operation process fails to be completed, detecting a target scenario which causes the currently executed operation process to fail to be completed;
restoring the currently executed operation process to a target operation process according to the target scenario; and
executing the target operation process, wherein the target operation process is used for continuing to realize the deletion of the cache partition starting from a target partition state of the cache partition which is indicated by the target scenario.

In an exemplary embodiment, restoring the currently executed operation process to a target operation process according to the target scenario includes:
extracting, from one or more operation steps included in the currently executed operation process, one or more target operation steps allowed to be executed in the target partition state of the cache partition indicated by the target scenario; and
creating the target operation process including the one or more target operation steps.

In an exemplary embodiment, extracting, from one or more operation steps included in the currently executed operation process, one or more target operation steps allowed to be executed in the target partition state of the cache partition indicated by the target scenario includes:
searching the one or more operation steps included in the operation process for operation steps, which are executed after the partition state of the cache partition reaches the target partition state, as candidate operation steps; and
editing the candidate operation steps according to the target partition state to obtain the one or more target operation steps.

In an exemplary embodiment, editing the candidate operation steps according to the target partition state to obtain the one or more target operation steps includes:
in cases where the target partition state indicates that there is a cache partition, adding an operation parameter restoration step before the candidate operation steps to obtain the one or more target operation steps, wherein the operation parameter restoration step is used for restoring operation parameters used by a cache partition configuration end in the target operation process; and
in response to the target partition state indicating no presence of any cache partition, filtering out operation steps from a candidate list that would be executed in situations with presencing cache partition, thereby obtaining the one or more targeted operation steps.

In an exemplary embodiment, executing the target operation process includes:
in cases where the one or more target operation steps include the operation parameter restoration step and the candidate operation steps, executing the operation parameter restoration step, wherein the operation parameter restoration step is used for acquiring target operation parameters stored by a cache partition service end to serve as the operation parameters used by the cache partition configuration end in the target operation process; and
executing the candidate operation steps using the target operation parameters.

In an exemplary embodiment, creating the target operation process including the one or more target operation steps includes:
acquiring an operation logic of the one or more target operation steps; and
connecting the one or more target operation steps according to the operation logic to obtain the target operation process.

In an exemplary embodiment, restoring the currently executed operation process to a target operation process according to the target scenario includes:
acquiring a scenario and a reference operation process having a correlation, wherein the reference operation process is used for continuing to realize the deletion of the cache partition in a corresponding scenario; and
searching the scenario and the reference operation process having the correlation, for a reference operation process corresponding to the target scenario as the target operation process.

In an exemplary embodiment, in cases where the currently executed operation process is a data invalidation process, restoring the currently executed operation process to a target operation process according to the target scenario includes:
in cases where the target scenario indicates that the cache partition is recreated and the recreation is successful, determining that the target operation process includes a data invalidation parameter restoration step and steps in the data invalidation process, wherein the data invalidation parameter restoration step is used for restoring data invalidation parameters used by the cache partition configuration end in the data invalidation process; and
in cases where the target scenario indicates that the cache partition is recreated but the recreation is not successful, determining that the target operation process includes a service end notification step and a service configuration processing step, wherein the service end notification step is used for notifying a cache partition service end of the cache partition to cancel a correlation between the cache partition and a volume, and the service configuration processing step is used for clearing a service configuration of the cache partition.

In an exemplary embodiment, executing the target operation process includes:
in cases where the target operation process includes the data invalidation parameter restoration step and the steps in the data invalidation process, executing the data invalidation parameter restoration step to obtain target data invalidation parameters; and
executing the steps in the data invalidation process according to the target data invalidation parameters.

In an exemplary embodiment, executing the data invalidation parameter restoration step to obtain target data invalidation parameters includes:
acquiring data invalidation parameters of the cache partition from the cache partition service end of the cache partition; and
in cases where the data invalidation parameters of the cache partition service end of the cache partition are acquired, determining the data invalidation parameters of the cache partition service end as the target data invalidation parameters.

In an exemplary embodiment, acquiring data invalidation parameters of the cache partition from the cache partition service end of the cache partition includes:
sending a first reference count to the cache partition service end, wherein the first reference count is a reference count of a number of accelerated volumes stored by the cache partition configuration end;
receiving a second reference count returned by the cache partition service end according to the first reference count, wherein the second reference count is a reference count of the number of the accelerated volumes stored by the cache partition service end, and the second reference count is sent to the cache partition configuration end in response to the cache partition service end determining that the first reference count is not equal to the second reference count; and
upon reception of the second reference count, determining that the data invalidation parameters of the cache partition service end have been acquired.

In an exemplary embodiment, detecting the operation state of a currently executed current operation process includes:
detecting whether the cache partition fails during execution of the currently executed operation process;
in cases where it is detected that the cache partition has failed, determining that the operation state indicates that the currently executed operation process cannot be completed; and
in cases where it is detected that the cache partition has not failed, determining that the operation state indicates that the currently executed operation process can be completed.

In an exemplary embodiment, detecting the target scenario which causes the currently executed operation process to fail to be completed includes:
determining a target failure causing the currently executed operation process to fail to be completed;
detecting an operation state of a recreation operation performed on the cache partition after the target failure occurs; and
determining the target scenario according to the operation state.

According to another embodiment of the present application, provided is a storage node, including a cache partition configuration end and a cache partition service end, wherein the cache partition configuration end is configured to delete, in a process of deleting a cache partition in a storage node, an operation state of a currently executed current operation process, wherein the deletion of the cache partition includes one or more operation processes, and the one or more operation processes include the currently executed operation process; in cases where it is detected that the operation state indicates that the currently executed operation process fails to be completed, detect a target scenario which causes the currently executed operation process to fail to be completed; restore the currently executed operation process to a target operation process according to the target scenario; and execute the target operation process, wherein the target operation process is used for continuing to delete the described cache partition from a target partition state of the described cache partition indicated by the described target scenario;
the cache partition service end is configured to execute, in the process of the cache partition configuration end executing the target operation process, an instruction given by the cache partition configuration end.

In an exemplary embodiment, the cache partition configuration end is configured to execute the operation parameter restoration step in cases where the target operation steps include the operation parameter restoration step, wherein the operation parameter restoration step is used for acquiring target operation parameters stored by a cache partition service end to serve as the operation parameters used by the cache partition configuration end in the target operation process; and continue executing the target operation process using the target operation parameters; and
the cache partition service end is configured to provide the target operation parameters for the cache partition configuration end.

In an exemplary embodiment, in cases where the currently executed operation process is a data invalidation process,
the cache partition configuration end is configured to determine, in cases where the target scenario indicates that the cache partition is recreated and the recreation is successful, that the target operation process includes a data invalidation parameter restoration step and steps in the data invalidation process, wherein the data invalidation parameter restoration step is used for restoring data invalidation parameters used by the cache partition configuration end in the data invalidation process; and execute the data invalidation parameter restoration step to obtain target data invalidation parameters; execute the steps in the data invalidation process according to the target data invalidation parameters;
the cache partition service end is configured to provide the target data invalidation parameters for the cache partition configuration end.

In an exemplary embodiment, the cache partition configuration end is configured to send a first reference count to the cache partition service end, wherein the first reference count is a reference count of a number of accelerated volumes stored by the cache partition configuration end; receive a second reference count returned by the cache partition service end according to the first reference count, wherein the second reference count is a reference count of the number of accelerated volumes stored by the cache partition service end; upon reception of the second reference count, determine the second reference count as the target data invalidation parameter;
the cache partition service end is configured to receive the first reference count sent by the cache partition configuration end; determine whether the first reference count equals the second reference count; and send the second reference count to the cache partition configuration end when determining that the first reference count is not equal to the second reference count.

According to another embodiment of the present application, provided is an apparatus for controlling storage resources in a storage node, including:
a first detection module, configured to detect an operation state of a currently executed current operation process in a process of deleting a cache partition in a storage node, wherein the deletion of the cache partition includes one or more operation processes, and the one or more operation processes include the currently executed operation process;
a second detection module, configured to detect, in cases where it is detected that the operation state indicates that the currently executed operation process fails to be completed, a target scenario which causes the currently executed operation process to fail to be completed;
a restoration module, configured to restore the currently executed operation process to a target operation process according to the target scenario; and
an execution module, configured to execute the target operation process, wherein the target operation process is used for continuing to realize the deletion of the cache partition starting from a target partition state of the cache partition which is indicated by the target scenario.

According to another embodiment of the present application, further provided is a computer readable storage medium storing a computer program, wherein the computer program is configured to execute, when running, the steps in any one of the described method embodiments.

According to another embodiment of the present application, further provided is an electronic device, including a memory and a processor, wherein the memory stores a computer program, and the processor is configured to run the computer program to execute the steps in any one of the method.

By means of the present application, the deletion of the cache partition includes one or more operation processes: in a process of deleting a cache partition in a storage node, performing real-time detection on the operation state of each currently executed current operation process; if it is found that the currently executed operation process fails to be completed, detecting the reason causing its failure to complete as the target scenario, and restoring the currently executed operation process according to the target scenario, to obtain a target operation process; and executing the target operation process to enable the deletion of the cache partition to continue from the target partition state of the cache partition to be deleted, as indicated by the target scenario, thereby successfully deleting the cache partition. Therefore, the problem of low success rate in deleting cache partitions in the storage node can be solved, thereby achieving the effect of improving the success rate of deleting cache partitions in the storage node.

### BRIEF DESCRIPTION OF THE DRAWINGS

FIG. 1 is a hardware structure block diagram of a mobile terminal in a method for controlling storage resources in a storage node according to an embodiment of the present application;

FIG. 2 is a flowchart of a method for controlling storage resources in a storage node according to an embodiment of the present application;

FIG. 3 is a schematic diagram of a process of deleting a cache partition according to an optional implementation of the present application;

FIG. 4 is a schematic diagram I of a storage node according to an embodiment of the present application;

FIG. 5 is a schematic diagram II of a storage node according to an embodiment of the present application;

FIG. 6 is a schematic diagram III of a storage node according to an embodiment of the present application;

FIG. 7 is a schematic diagram IV of a storage node according to an embodiment of the present application;

FIG. 8 is a structural block diagram of an apparatus for controlling storage resources in a storage node according to an embodiment of the present application.

### DETAILED DESCRIPTION

The embodiments of the present application are described in detail with reference to the accompanying drawings and in conjunction with the embodiments.

It should be noted that, the terms “first”, “second”, etc. in the description, claims and drawings of the present application are used to distinguish similar objects, and do not need to be used to describe a specific order or sequence.

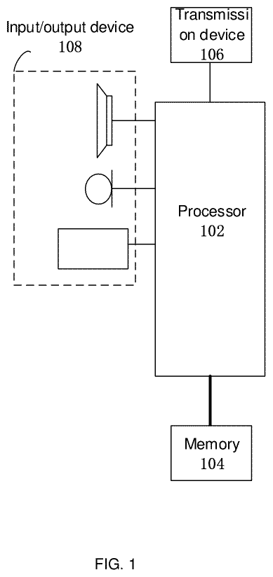

The method embodiment provided in the embodiment I of the present application may be executed in a mobile terminal, a computer terminal, or a similar computing device. By taking running on a mobile terminal as an example. FIG. 1 is a hardware structure block diagram of a mobile terminal for a method for controlling storage resources in a storage node according to an embodiment of the present application. As shown in FIG. 1, the mobile terminal may include one or more (only one is shown in FIG. 1) processors 102 (the processors 102 may include, but are not limited to, a microprocessor MCU or a processing device such as a programmable logic device FPGA) and a memory 104 configured to store data, wherein the mobile terminal can further include a transmission device 106 for a communication function and an input/output device 108. Those ordinarily skilled in the art can appreciate that the structure shown in FIG. 1 is for illustrative purposes only, but not limit the structure of the mobile terminal. For example, the mobile terminal may also include more or fewer components than that shown in FIG. 1, or have a different configuration than that shown in FIG. 1.

The memory 104 may be configured to store a computer program, for example, a software program and a module of application software, such as a computer program corresponding to the method for controlling storage resources in a storage node in the embodiment of the present application. The processor 102 runs the computer program stored in the memory 104, so as to execute various function applications and data processing, that is, to implement the foregoing method. The memory 104 may include a high-speed random access memory, and may also include a non-transitory memory, such as one or more magnetic storage apparatuses, flash memories, or other non-transitory solid-state memories. In some instances, the memory 104 may further include memories remotely arranged with respect to the processor 102, and these remote memories may be connected to the mobile terminal over a network. Examples of the described network include, but are not limited to the Internet, an intranet, a local area network, a mobile communication network, and a combination thereof.

The transmission device 106 is configured to receive or transmit data over a network. Optional examples of the described network may include a wireless network provided by a communication provider of the mobile terminal. In one example, the transmission device 106 includes a network interface controller (NIC) which may be connected to other network devices by means of a base station, thereby being able to communicate with the Internet. In one example, the transmission device 106 may be a radio frequency (RF) module for communicating wirelessly with the Internet.

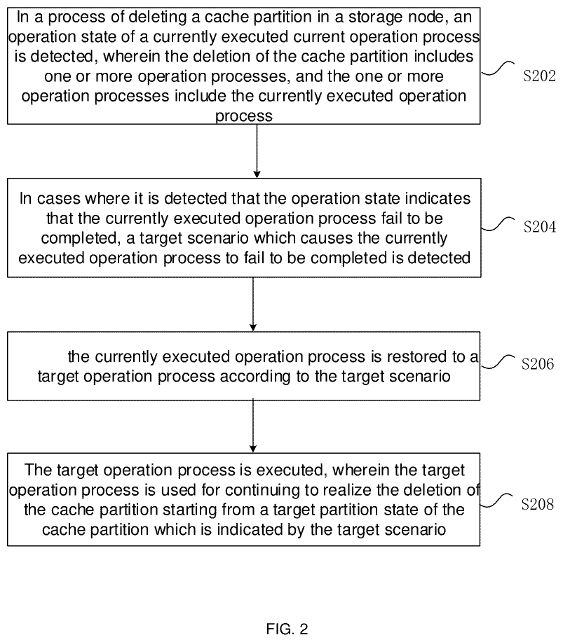

Provided in the present embodiment is a method for controlling storage resources in a storage node. FIG. 2 is a flowchart of a method for controlling storage resources in a storage node according to an embodiment of the present application. As shown in FIG. 2, the process includes the following steps:
step S202: in a process of deleting a cache partition in a storage node, an operation state of a currently executed current operation process is detected, wherein the deletion of the cache partition includes one or more operation processes, and the one or more operation processes include the currently executed operation process;
step S204: in cases where it is detected that the operation state indicates that the currently executed operation process fails to be completed, a target scenario which causes the currently executed operation process to fail to be completed is detected;
step S206: the currently executed operation process is restored to a target operation process according to the target scenario; and
step S208: the target operation process is executed, wherein the target operation process is used for continuing to realize the deletion of the cache partition starting from a target partition state of the cache partition which is indicated by the target scenario.

By means of the described steps, the deletion of the cache partition includes one or more operation processes: in a process of deleting a cache partition in a storage node, performing real-time detection on the operation state of each currently executed current operation process; if it is found that the currently executed operation process fails to be completed, detecting the reason causing its failure to complete as the target scenario, and restoring the current operation process according to the target scenario, to obtain a target operation process; and executing the target operation process to enable the deletion of the cache partition to continue from the target partition state of the cache partition to be deleted, as indicated by the target scenario, thereby successfully deleting the cache partition. Therefore, the problem of low success rate in deleting cache partitions in the storage node can be solved, thereby achieving the effect of improving the success rate of deleting cache partitions in the storage node.

In an embodiment of the present application, the method for controlling storage resources in the storage node may be applied to, but not limited to, a storage node, for example, applied to a cache partition configuration end in a storage node. The present application can also be applied to a device independent of a storage node and having a storage node control function, and the device monitors and repairs a deletion process of a cache partition in the storage node, thereby ensuring smooth deletion of the cache partition.

Taking the application to the cache partition configuration end with the currently executed operation process being the data invalidation process as an example, during the process of deleting a cache partition in a storage node, the cache partition configuration end detects the operation state of the data invalidation process, wherein the data invalidation process is used to invalidate the accelerated volume data in the cache partition; if it is detected that the data invalidation process cannot be completed, the cache partition configuration end detects the target scenario causing the failure of the data invalidation process, i.e., detects the reason for its failure; the cache partition configuration end recovers the data invalidation process to a target cache partition deletion process on the basis of the target scenario, wherein the target cache partition deletion process is used for continuing to realize the deletion of the cache partition starting from a target partition state of the cache partition which is indicated by the target scenario, and the cache partition configuration end executes the target cache partition deletion process on the cache partition, thereby ensuring the successful deletion of the cache partition.

In the technical solution provided in step S202, the storage node may be, but is not limited to, any type of storage node capable of creating and deleting a cache partition, for example, in a solid state disk (SSD), when memory resources are allocated in a Linux system, a cache partition created on the SSD is used to perform data acceleration on a volume created by the HDD, the volume created by the HDD stores the address pointer of the cache partition created by the SSD and a flag bit indicating whether cache acceleration is enabled. When the volume created by the HDD disables the cache partition acceleration relationship, the cache partition will invalidate the data corresponding to the volume created by the HDD; if there are many pieces hit data in the cache partition, the time required for invalidating the data will correspondingly increase; if a failure occurs in the node in the data invalidation process in the cache partition, the data invalidation process in the cache partition cannot be completed, and the reference count of the number of accelerated volumes in the cache partition does not subtract the corresponding volume, thus, the reference count of the accelerated volumes stored in the cache partition configuration end will be inconsistent with the reference count of the accelerated volumes stored in the cache partition service end; when deleting the cache partitions, the cache partition configuration end will check whether the reference count is 0; if it is not 0, it indicates that the cache partition is still accelerating the volume, and deletion will be restricted because the service end may still be storing the acceleration relationship between the cache partition and the volume. Thus, the failure to complete the volume data invalidation process will lead to the failure of deleting the cache partition.

In an embodiment of the present application, the deletion of the cache partition includes one or more operation processes, such as a data invalidation process, a deletion task initiation process, and a cache partition reclaiming process. In the process of executing each operation process, the operation state of the operation process is detected, and the operation process is specifically restored according to different operation states and causes of different operation states, thereby ensuring that a cache partition can be successfully deleted.

In an embodiment of the present application, the operation state of the currently executed operation process may include a “failed to complete” state and an “able to complete” state; the “failed to complete” state indicates that the currently executed operation process cannot be completed, and the “able to complete” indicates that the currently executed operation process can be completed; according to the execution parameters and information when the currently executed operation process is executed, it is predicted whether the currently executed operation process can be completed, so as to perform the corresponding processing according to the determination, and ensure smooth deletion of the cache partition.

In an embodiment of the present application, whether the currently executed operation process can be completed may be determined according to, but not limited to, an error or a failure occurred during the execution of the currently executed operation process. For example, if no error or failure occurs during the execution of the currently executed operation process, the currently executed operation process can be completed. If errors or failures occur during the execution of the currently executed operation process, some errors or failures may be repaired on their own, and it is considered that the currently executed operation process can also be completed. For those errors or failures that cannot be repaired on their own, it may be considered that the currently executed operation process fails to be completed.

In an exemplary embodiment, the operation state of the currently executed current operation process may be detected in, but not limited to, the following manners: detecting whether a cache partition fails during the execution of the currently executed operation process; in cases where it is detected that the cache partition has failed, determining that the operation state indicates that the currently executed operation process cannot be completed; and in cases where it is detected that the cache partition has not failed, determining that the operation state indicates that the currently executed operation process can be completed.

In an embodiment of the present application, the operation state may be determined by, but not limited to, performing failure detection on the currently executed operation process. The failure may include, but is not limited to, a high availability (HA) failure. If an HA failure occurs in a storage node, a cache partition needs to be recreated; if the cache partition is recreated successfully, an operation process cannot be completed because the reference count of the number of accelerated volumes stored in a cache partition configuration end is inconsistent with the reference count of the number of accelerated volumes stored in a cache partition service end; and if the cache partition is recreated unsuccessfully, an operation process cannot be completed because the cache partition does not exist.

In the technical solution provided in step S204, the target scenario may be, but is not limited to, used for indicating a reason for which the currently executed operation process fails to be completed, for example, a target scenario may include, but is not limited to, an operation parameter error, a cache partition error, etc., wherein the operation parameter error indicates that the currently executed operation process fails to be completed due to reasons such as inconsistency of operation parameters, and the cache partition error indicates that the currently executed operation process fails to be completed due to reasons such as that the cache partition does not exist.

In an embodiment of the present application, the target scenario may be analyzed according to, but not limited to, whether the cache partition is successfully recreated after the failure occurs.

In an exemplary embodiment, a target scenario that causes the currently executed operation process to fail to be completed may be detected in, but not limited to, the following manners: determining a target failure that causes the currently executed operation process to fail to be completed; detecting an operation state of a recreation operation performed on the cache partition after the target failure occurs; and determining the target scenario according to the operation state.

In an embodiment of the present application, the target scenario that fails to complete the currently executed operation process may be analyzed, but is not limited to, by using the operation state of executing the recreation operation on the cache partition after the target failure occurs. The target failure may be, but is not limited to, the HA failure. For example, the operation state of the recreation operation may include but is not limited to success and failure, and if the operation state is success, the target scenario may be that the cache partition is successfully recreated, but the reference count of the number of accelerated volumes stored in the cache partition configuration end is inconsistent with the reference count of the number of accelerated volumes stored in the cache partition service end, which results in that the operation process cannot be completed. If the operation state is success, the target scenario may be that the cache partition is recreated unsuccessfully, that is, the cache partition does not exist, which causes that the operation process cannot be completed.

In the technical solution provided in step S206, a corresponding restoration operation may be performed on the currently executed operation process according to a target scenario that leads to that the currently executed operation process fails to be completed, so as to obtain the target operation process. The restoration operation may include, but is not limited to, deletion, modification and addition of a process, and deletion, modification and addition of a step in the process, etc. Thus, it is ensured that the execution of the target operation process can continue to achieve the deletion of the cache partition from the target partition state indicated by the target scenario.

In an exemplary embodiment, the currently executed operation process may be restored to the target operation process according to the target scenario in, but not limited to, the following manners: extracting, from one or more operation steps included in the currently executed operation process, one or more target operation steps allowed to be executed in the target partition state of the cache partition indicated by the target scenario; and creating the target operation process including the one or more target operation steps.

In an embodiment of the present application, each operation process may have one or more operation steps, and each operation step enables the cache partition to reach an intermediate state in the deletion process; on the basis of the partition state of the cache partition indicated by the target scenario, one or more operation steps that will be executed after the cache partition reaches the target partition state are extracted, so as create the target operation process is created on the basis of these extracted one or more target operation steps, so that the cache partition can continue to execute the process of deleting the cache partition along the current target partition state of the cache partition, in this way, it is ensured that the cache partition can be deleted successfully.

In an exemplary embodiment, one or more target operation steps allowed to be executed in the target partition state of the cache partition indicated by the target scenario may be extracted from one or more operation steps included in the currently executed operation process in, but not limited to, the following manners: searching the one or more operation steps included in the operation process for operation steps, which are executed after the partition state of the cache partition reaches the target partition state, as candidate operation steps; and editing the candidate operation steps according to the target partition state to obtain the one or more target operation steps.

In an embodiment of the present application, the extraction process of the target operation step may include, but is not limited to, two stages: filtering and editing of the operation step. Firstly, operation steps executed after the partition state of the cache partition reaches a target partition state are found to serve as candidate operation steps, and then the candidate operation steps are edited according to the target partition state, so as to obtain target operation steps which can be successfully executed in the target partition state.

In an exemplary embodiment, the candidate operation steps can be edited according to the target partition state, so as to obtain one or more target operation steps, in, but not limited to, the following manners: in cases where the target partition state indicates that there is a cache partition, adding an operation parameter restoration step before the candidate operation steps to obtain the one or more target operation steps, wherein the operation parameter restoration step is used for restoring operation parameters used by a cache partition configuration end in the target operation process; and in response to the target partition state indicating no presence of any cache partition, filtering out operation steps from a candidate list that would be executed in situations with presencing cache partition, thereby obtaining the one or more targeted operation steps.

In an embodiment of the present application, the target partition state may, but is not limited to, indicate whether the cache partition exists currently.

In an embodiment of the present application, if the target partition state indicates that the cache partition still exists, an operation parameter restoration step may be added before the candidate operation step to restore the operation parameters used by the cache partition configuration end in the target operation process, so that the obtained target operation step can continue to be performed.

In an embodiment of the present application, if the target partition state indicates that the cache partition does not exist, operation steps executed when the cache partition exists are filtered out from candidate operation steps to obtain one or more target operation steps. The operation steps executed when the cache partition exists may include, but are not limited to, a step of initiating a partition deletion task, etc.

In an exemplary embodiment, a target operation process including one or more target operation steps can be created in, but not limited to, the following manners: acquiring an operation logic of the one or more target operation steps; and connecting the one or more target operation steps according to the operation logic to obtain the target operation process.

In an embodiment of the present application, one or more target operation steps are connected according to a certain operation logic, so as to obtain a target operation process to continue the execution.

In an exemplary embodiment, the currently executed operation process may be restored to a target operation process according to a target scenario in, but not limited to, the following manners: acquiring a scenario and a reference operation process having a correlation, wherein the reference operation process is used for continuing to realize the deletion of the cache partitions in a corresponding scenario; and searching the scenario and the reference operation process having the correlation, for a reference operation process corresponding to the target scenario as the target operation process.

In an embodiment of the present application, how to continue the deletion of the cache partition under different scenarios can also be pre-configured; scenarios and reference operation processes having a correlation can be stored in advance to define how to continue the deletion of the cache partition under different scenarios; after the target scenario is detected, the reference operation process corresponding to the target scenario can be found from the scenarios and reference operation processes having a correlation and used as the target operation process to continue the execution.

For example, in a reference operation process corresponding to the scenario, in which an HA failure occurs but a cache partition is successfully recreated, operation parameters may be restored first, and then the cache partition is continuously deleted by using the restored operation parameters. In a reference operation process corresponding to the scenario, in which an HA failure occurs and the cache partition recreation fails, the process of deleting the cache partition may be directly skipped to process the configuration information directly.

In an exemplary embodiment, in cases where the currently executed operation process is a data invalidation process, the currently executed operation process may be restored to the target operation process according to the target scenario in, but not limited to, the following manners: in cases where the target scenario indicates that the cache partition is recreated and the recreation is successful, determining that the target operation process includes a data invalidation parameter restoration step and steps in the data invalidation process, wherein the data invalidation parameter restoration step is used for restoring data invalidation parameters used by the cache partition configuration end in the data invalidation process; and in cases where the target scenario indicates that the cache partition is recreated but the recreation is not successful, determining that the target operation process includes a service end notification step and a service configuration processing step, wherein the service end notification step is used for notifying a cache partition service end of the cache partition to cancel a correlation between the cache partition and a volume, and the service configuration processing step is used for clearing a service configuration of the cache partition.

In an embodiment of the present application, for example, the currently executed operation process is a data invalidation process, if the target scenario is that the cache partition is recreated and the recreation is successful, the data invalidation parameter restoration step and the steps in the data invalidation process are used as the target operation process to continue the execution, so as to restore the data invalidation parameters used by the cache partition configuration end in the data invalidation process and continue with the data invalidation process; if the target scenario is that the cache partition is recreated but the recreation is not successful, a service end notification step and a service configuration processing step are included in the target operation process to continue the execution, so as to directly notify the cache partition service end of the cache partition to cancel a correlation between the cache partitions and the volumes, skip the process of initiating the partition deletion task, and clear the service configuration of the cache partition.

In the technical solution provided in step S208, a restored target operation process is executed, so that the process of deleting a cache partition can continue to be performed from the target partition state of the cache partition indicated by the target scenario, thereby implementing deletion of the cache partition.

In an exemplary embodiment, the target operation process may be executed in, but not limited to, the following manners: in cases where the one or more target operation steps include the operation parameter restoration step and the candidate operation step, executing the operation parameter restoration step, wherein the operation parameter restoration step is used for acquiring target operation parameters stored by a cache partition service end to serve as the operation parameters used by the cache partition configuration end in the target operation process; and executing the candidate operation steps using the target operation parameters.

In an embodiment of the present application, if the cache partition is successfully recreated after a failure occurs, the target operation parameters stored by the cache partition service end may be obtained by means of the operation parameter restoration step and are used as the operation parameters used by the cache partition configuration end in the target operation process, and then the candidate operation steps in the currently executed operation process continue to be performed.

In an exemplary embodiment, the target operation process may be executed in, but is not limited to, the following manners: in cases where the target operation process includes the data invalidation parameter restoration step and the steps in the data invalidation process, executing the data invalidation parameter restoration step to obtain target data invalidation parameters; and executing the steps in the data invalidation process according to the target data invalidation parameters.

In an embodiment of the present application, in cases where the currently executed operation process is a data invalidation process, the target data invalidation parameters may be obtained by executing a data invalidation parameter restoration step, and then the steps in the data invalidation process continue to be executed according to the target data invalidation parameters, thereby implementing deletion of the cache partition.

In an exemplary embodiment, the data invalidation parameter restoration step may be executed to obtain target data invalidation parameters in, but is not limited to, the following manners: acquiring data invalidation parameters of the cache partition from the cache partition cache service end of the cache partition and in cases where the data invalidation parameters of the cache partition service end of the cache partition are acquired, determining the data invalidation parameters of the cache partition service end as the target data invalidation parameters.

In an embodiment of the present application, the target data invalidation parameters that are used in the process of continuing to execute data invalidation may be, but is not limited to, data invalidation parameters recorded by the cache partition service end.

In an embodiment of the present application, the data invalidation parameters recorded by the cache partition service end may be obtained by, but not limited to, sending an instruction or a request to the cache partition service end. Alternatively, the data invalidation parameters recorded by the cache partition service end may also be acquired by, but is not limited to, executing an interaction process appointed with the cache partition service end.

In an exemplary embodiment, the data invalidation parameters of the cache partition may be acquired from the cache partition service end of the cache partition in, but is not limited to, the following manners: sending a first reference count to the cache partition service end, wherein the first reference count is a reference count of a number of accelerated volumes stored by the cache partition configuration end; receiving a second reference count returned by the cache partition service end according to the first reference count, wherein the second reference count is a reference count of the number of the accelerated volumes stored by the cache partition service end, and the second reference count is sent to the cache partition configuration end in response to the cache partition service end determining that the first reference count is not equal to the second reference count; and upon reception of the second reference count, determining that the data invalidation parameters of the cache partition service end have been acquired.

In an embodiment of the present application, the first reference count of the number of the accelerated volumes stored by the cache partition configuration end is first sent to the cache partition service end; the cache partition service end compares the first reference count with a second reference count stored therein, to determine whether the two are consistent; if the two are inconsistent, the cache partition service end returns a second reference count; and after the second reference count returned by the cache partition service end has been received, the second reference count can be used as the target data invalidation parameter in the subsequent data invalidation process.

In an embodiment of the present application, after step S208, it is permissible, but not limited to, executing a next operation process of the currently executed operation process among the one or more operation processes when the target operation process has been completed.

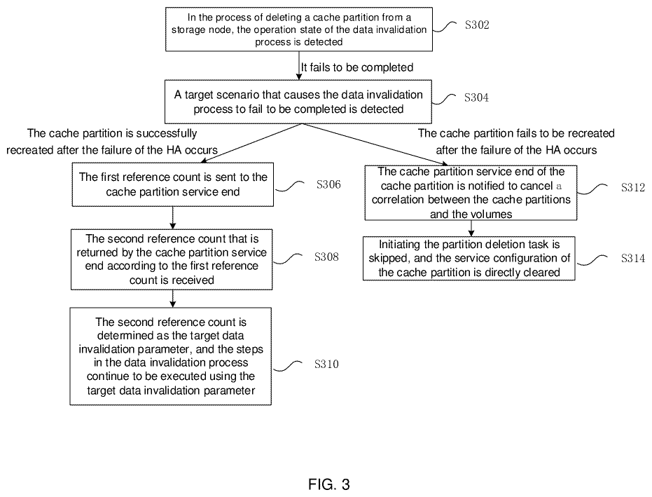

In an optional implementation, a process of deleting a cache partition is provided. FIG. 3 is a schematic diagram of a process of deleting a cache partition according to an optional implementation of the present application. As shown in FIG. 3, the process includes the following steps:
step S302: in the process of deleting a cache partition from a storage node, the operation state of the data invalidation process is detected, wherein if it is detected that the operation state of the data invalidation process indicates that the data invalidation process cannot be completed, step S304 is performed, and if it is detected that the operation state of the data invalidation process indicates that the data invalidation process can be completed, the operation of deleting the cache partition from the storage node continues to be executed;
step S304: a target scenario that causes the data invalidation process to fail to be completed is detected, wherein if the cache partition is successfully recreated after the failure of the HA occurs, step S306 to step S310 are executed, and if the cache partition fails to be recreated after the failure of the HA occurs, step S312 to step S314 are executed;
step S306: the first reference count is sent to the cache partition service end;
step S308: the second reference count that is returned by the cache partition service end according to the first reference count is received;
step S310: the second reference count is determined as the target data invalidation parameter, and the steps in the data invalidation process continue to be executed using the target data invalidation parameter;
step S312: the cache partition service end of the cache partition is notified to cancel the correlation between the cache partitions and the volumes; and
step S314: initiating the partition deletion task is skipped, and the service configuration of the cache partition is directly cleared.

By means of the described process, if the cache partition cannot be deleted because the failed data cannot be completed, it is first distinguished which scenario results in that the data invalidation cannot be completed, and different partition deletion processes are initiated for different scenarios. In this way, it is ensured that the deletion of the cache partition can be completed in different scenarios.

From the description of the described embodiments, a person skilled in the art would have been able to clearly understand that the method in the described embodiments may be implemented by using software and necessary general hardware platforms, and of course may also be implemented using hardware, but in many cases, the former is a better embodiment. Based on such understanding, the essence of technical solution of the embodiments of the present application, or in other words, the part of the technical solutions making contributions to the prior art, may be embodied in the form of a software product stored in a non-volatile readable storage medium (such as a Read-Only Memory (ROM)/Random Access Memory (RAM), a magnetic disk and an optical disc), including a number of instructions for enabling a terminal device (which may be a mobile phone, a computer, a server, or a network device, etc.) to perform the methods described in various embodiments of the present application.

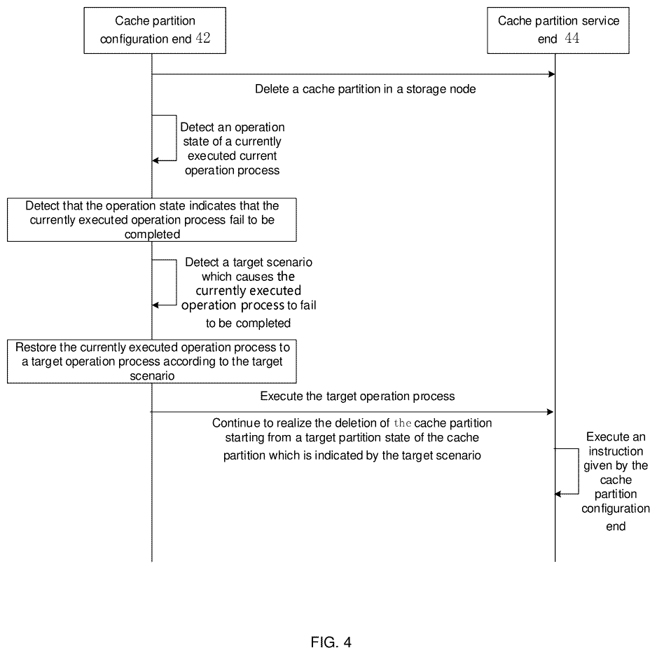

A storage node is further provided in the present embodiment. FIG. 4 is a schematic diagram I of a storage node according to an embodiment of the present application. As shown in FIG. 4, the storage node includes a cache partition configuration end 42 and a cache partition service end 44, wherein
the cache partition configuration end 42 is configured to delete, in a process of deleting a cache partition in a storage node, an operation state of a currently executed current operation process, wherein the deletion of the cache partition includes one or more operation processes, and the one or more operation processes include the currently executed operation process; in cases where it is detected that the operation state indicates that the currently executed operation process fail to be completed, detect a target scenario which causes the currently executed operation process to fail to be completed; restore the currently executed operation process to a target operation process according to the target scenario; and execute the target operation process, wherein the target operation process is used for continuing to realize the deletion of the cache partition starting from a target partition state of the cache partition which is indicated by the target scenario; and
the cache partition service end 44 is configured to execute, in the process of the cache partition configuration end executing the target operation process, an instruction given by the cache partition configuration end.

By means of the described device, the deletion of the cache partition includes one or more operation processes: in a process of deleting a cache partition in a storage node, performing real-time detection on the operation state of each currently executed current operation process; if it is found that the currently executed operation process fails to be completed, detecting the reason causing its failure to complete as the target scenario, and restoring the current operation process according to the target scenario, to obtain a target operation process; and executing the target operation process to enable the deletion of the cache partition to continue from the target partition state of the cache partition to be deleted, as indicated by the target scenario, thereby successfully deleting the cache partition. Therefore, the problem of low success rate in deleting cache partitions in the storage node can be solved, thereby achieving the effect of improving the success rate of deleting cache partitions in the storage node.

In an exemplary embodiment, the cache partition configuration end is further configured to extract, from one or more operation steps included in the currently executed operation process, one or more target operation steps allowed to be executed in the target partition state of the cache partition indicated by the target scenario; and create the target operation process including the one or more target operation steps.

In an exemplary embodiment, the cache partition configuration end is further configured to search the one or more operation steps included in the operation process for operation steps, which are executed after the partition state of the cache partition reaches the target partition state, as candidate operation steps; and edit the candidate operation steps according to the target partition state to obtain the one or more target operation steps.

In an exemplary embodiment, the cache partition configuration terminal is further configured to add, in cases where the target partition state indicates that there is a cache partition, an operation parameter restoration step before the candidate operation steps to obtain the one or more target operation steps, wherein the operation parameter restoration step is used for restoring operation parameters used by a cache partition configuration end in the target operation process; and in response to the target partition state indicating no presence of any cache partition, filtering out operation steps from a candidate list that would be executed in situations with presencing cache partition, thereby obtaining the one or more targeted operation steps.

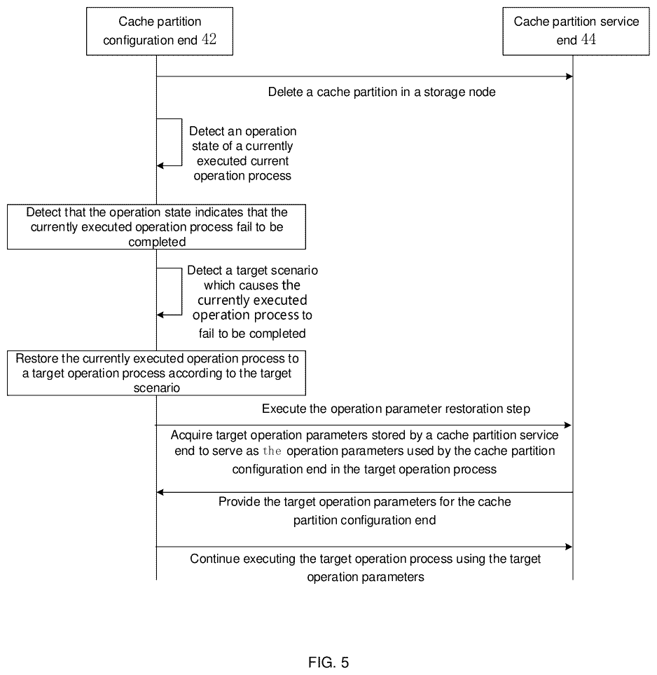

In an exemplary embodiment, FIG. 5 is a schematic diagram Il of a storage node according to an embodiment of the present application, as shown in FIG. 5, the cache partition configuration end 42 is configured to execute the operation parameter restoration step in cases where the target operation steps include the operation parameter restoration step, wherein the operation parameter restoration step is used for acquiring target operation parameters stored by a cache partition service end to serve as the operation parameters used by the cache partition configuration end in the target operation process; and continue executing the target operation process using the target operation parameters; and
the cache partition service end 44 is configured to provide the target operation parameters for the cache partition configuration end.

In an exemplary embodiment, the cache partition configuration end is further configured to acquire an operation logic of the one or more target operation steps; and connect the one or more target operation steps according to the operation logic to obtain the target operation process.

In an exemplary embodiment, the cache partition configuration end is further configured to acquire a scenario and a reference operation process having a correlation, wherein the reference operation process is used for continuing to realize the deletion of the cache partitions in a corresponding scenario; and search, from the scenario and the reference operation process having the correlation, for a reference operation process corresponding to the target scenario as the target operation process.

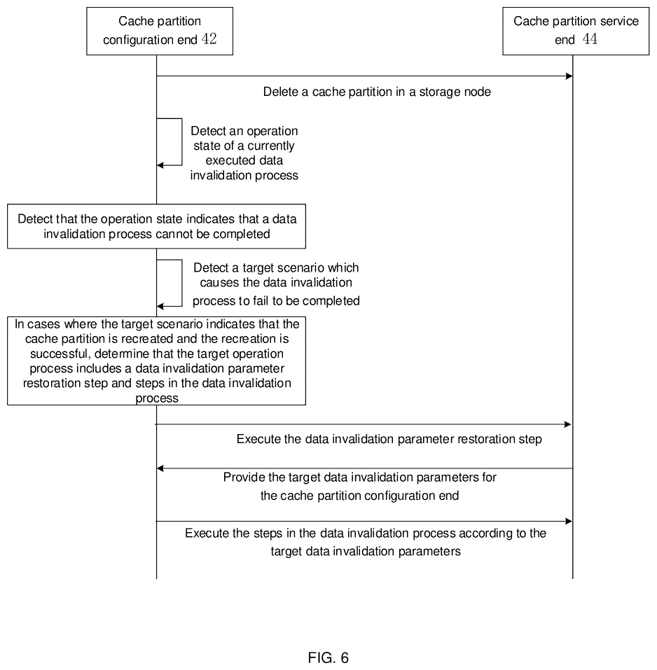

In an exemplary embodiment, FIG. 6 is a schematic diagram III of a storage node according to an embodiment of the present application, as shown in FIG. 6, in cases where the currently executed operation process is a data invalidation process, the cache partition configuration end 42 is configured to determine, in cases where the target scenario indicates that the cache partition is recreated and the recreation is successful, that the target operation process includes a data invalidation parameter restoration step and steps in the data invalidation process, wherein the data invalidation parameter restoration step is used for restoring data invalidation parameters used by the cache partition configuration end in the data invalidation process; and execute the data invalidation parameter restoration step to obtain target data invalidation parameters; execute the steps in the data invalidation process according to the target data invalidation parameters; the cache partition service end 44 is configured to provide the target data invalidation parameters for the cache partition configuration end.

In an exemplary embodiment, the cache partition configuration end is further configured to determine, in cases where the target scenario indicates that the cache partition is recreated but the recreation is not successful, that the target operation process includes a service end notification step and a service configuration processing step, wherein the service end notification step is used for notifying a cache partition service end of the cache partition to cancel a correlation between the cache partition and a volume, and the service configuration processing step is used for clearing a service configuration of the cache partition.

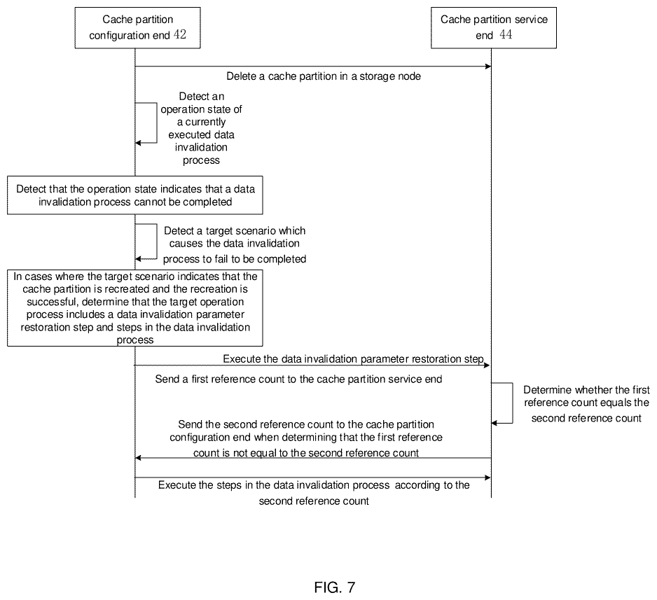

In an exemplary embodiment, FIG. 7 is a schematic diagram IV of a storage node according to an embodiment of the present application, as shown in FIG. 7, the cache partition configuration end 42 is configured to send a first reference count to the cache partition service end, wherein the first reference count is a reference count of a number of accelerated volumes stored by the cache partition configuration end; receive a second reference count returned by the cache partition service end according to the first reference count, wherein the second reference count is a reference count of the number of accelerated volumes stored by the cache partition service end; upon reception of the second reference count, determine the second reference count as the target data invalidation parameter;
the cache partition service end 44 is configured to receive the first reference count sent by the cache partition configuration end; determine whether the first reference count equals the second reference count; and send the second reference count to the cache partition configuration end when determining that the first reference count is not equal to the second reference count.

In an exemplary embodiment, the cache partition configuration end is further configured to detect whether the cache partition fails during execution of the currently executed operation process; in cases where it is detected that the cache partition has failed, determine that the operation state indicates that the currently executed operation process cannot be completed; and in cases where it is detected that the cache partition has not failed, determine that the operation state indicates that the currently executed operation process can be completed.

In an exemplary embodiment, the cache partition configuration end is further configured to determine a target failure causing the currently executed operation process to fail to be completed; detecting an operation state of a recreation operation performed on the cache partition after the target failure occurs; and determine the target scenario according to the operation state.

In an optional embodiment of the present application, a processing mechanism is proposed for a storage node to solve the problem of failure to delete a cache partition due to the inability to complete the data invalidation process. When a cache partition is deleted, a scenario in which the data invalidation process cannot be completed is determined first; if there are too many pieces of hit data in the cache partition, the time taken for the invalidating data of the corresponding accelerated volume is long, resulting in that an HA failure occurs in the process of invalidating data of the accelerated volume; a scenario may be that a cache partition is successfully recreated after the failure, but due to the failure, the cache partition service end cannot subtract 1 from the reference count for completing volume data invalidation and send same to the cache partition configuration end, resulting in that the reference count of the accelerated volumes stored in the cache partition configuration end will be inconsistent with the reference count of the accelerated volumes stored in the cache partition service end; another scenario may be that when an HA failure occurs in a cache partition and the cache partition is not correctly recreated, as the partition is not created, the cache partition service end cannot initiate a process of invalidating the data of the accelerated volume.

If the cache partition is successfully recreated after the failure, an interaction mechanism between the cache partition configuration end and the cache partition service end may be added; when deleting a partition, the cache partition configuration end sends the stored first reference count of the number of accelerated volumes to the cache partition service end; after receiving the message, the cache partition service end compares same with the stored second reference count of the accelerated volumes; and if they are not same, the second reference count of the cache partition service end is sent to the cache partition configuration end.

If the data invalidation process cannot be completed due to the cache partition not being created after a failure, when deleting the cache, the cache partition configuration end sends a message to the cache partition service end to confirm whether the cache partition is successfully created; if not, there is no need to invalidate the data; the cache partition configuration end sends a message to cancel a correlation between the cache partitions and the volumes at the cache partition service end; and the cache partition configuration end does not initiate a partition deletion task and processes the service configuration by itself.

The present embodiment further provides an apparatus for controlling storage resources in a storage node, the apparatus is used for implementing the embodiments and preferred embodiments above, and what has been described will not be described repeatedly here. As used below, the term “module” may implement a combination of software and/or hardware of predetermined functions. Although the apparatus described in the following embodiments is preferably implemented in software, implementation in hardware or a combination of software and hardware is also possible and conceived.

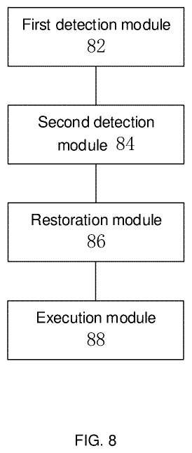

FIG. 8 is a structural block diagram of an apparatus for controlling storage resources in a storage node according to an embodiment of the present application. As shown in FIG. 8, the apparatus includes:
a first detection module 82, configured to detect an operation state of a currently executed current operation process in a process of deleting a cache partition in a storage node, wherein the deletion of the cache partition includes one or more operation processes, and the one or more operation processes include the currently executed operation process;
a second detection module 84, configured to detect, in cases where it is detected that the operation state indicates that the currently executed operation process cannot be completed, a target scenario which causes the currently executed operation process to fail to be completed;
a restoration module 86, configured to restore the currently executed operation process to a target operation process according to the target scenario; and
an execution module 88, configured to execute the target operation process, wherein the target operation process is used for continuing to realize the deletion of the cache partition starting from a target partition state of the cache partition which is indicated by the target scenario.

By means of the described apparatus, the deletion of the cache partition includes one or more operation processes: in a process of deleting a cache partition in a storage node, performing real-time detection on the operation state of each currently executed current operation process; if it is found that the currently executed operation process cannot be completed, detecting the reason causing its failure to complete as the target scenario, and restoring the current operation process according to the target scenario, to obtain a target operation process; and executing the target operation process to enable the deletion of the cache partition to continue from the target partition state of the cache partition to be deleted, as indicated by the target scenario, thereby successfully deleting the cache partition. Therefore, the problem of low success rate in deleting cache partitions in the storage node can be solved, thereby achieving the effect of improving the success rate of deleting cache partitions in the storage node.

In an exemplary embodiment, the restoration module includes:
an extraction unit, configured to extract, from one or more operation steps included in the currently executed operation process, one or more target operation steps allowed to be executed in the target partition state of the cache partition indicated by the target scenario; and
a creating unit, configured to create the target operation process including the one or more target operation steps.

In an exemplary embodiment, the extraction unit is configured to:
search the one or more operation steps included in the operation process for operation steps, which are executed after the partition state of the cache partition reaches the target partition state, as candidate operation steps; and
edit the candidate operation steps according to the target partition state to obtain the one or more target operation steps.

In an exemplary embodiment, the extraction unit is configured to:
in cases where the target partition state indicates that there is a cache partition, add an operation parameter restoration step before the candidate operation steps to obtain the one or more target operation steps, wherein the operation parameter restoration step is used for restoring operation parameters used by a cache partition configuration end in the target operation process; and
in response to the target partition state indicating no presence of any cache partition, filtering out operation steps from a candidate list that would be executed in situations with presencing cache partition, thereby obtaining the one or more targeted operation steps.

In an exemplary embodiment, the execution module includes:
a first execution unit, configured to execute the operation parameter restoration step in cases where the one or more target operation steps include the operation parameter restoration step and the candidate operation step, wherein the operation parameter restoration step is used for acquiring target operation parameters stored by a cache partition service end to serve as the operation parameters used by the cache partition configuration end in the target operation process; and
a second execution unit configured to execute the candidate operation steps using the target operation parameters.

In an exemplary embodiment, the described creation unit is configured to:
acquire an operation logic of the one or more target operation steps; and
connect the one or more target operation steps according to the operation logic to obtain the target operation process.

In an exemplary embodiment, the restoration module includes:
an acquisition unit configured to acquire a scenario and a reference operation process having a correlation, wherein the reference operation process is used for continuing to realize the deletion of the cache partitions in a corresponding scenario;
a search unit, configured to search, from the scenario and the reference operation process having the correlation, for a reference operation process corresponding to the target scenario as the target operation process.

In an exemplary embodiment, in cases where the currently executed operation process is a data invalidation process, the restoration module includes:
a first determination unit, configured to determine, in cases where the target scenario indicates that the cache partition is recreated and the recreation is successful, that the target operation process includes a data invalidation parameter restoration step and steps in the data invalidation process, wherein the data invalidation parameter restoration step is used for restoring data invalidation parameters used by the cache partition configuration end in the data invalidation process; and
a second determining unit, configured to, determine, in cases where the target scenario indicates that the cache partition is re-established but the re-establishment is not successful, that the target operation process includes a service end notification step and a service configuration processing step, wherein the service end notification step is used for notifying a cache partition service end of the cache partition to cancel a correlation between the cache partition and a volume, and the service configuration processing step is used for clearing a service configuration of the cache partition.

In an exemplary embodiment, the execution module includes:
a third execution unit, configured to execute the data invalidation parameter restoration step in cases where the target operation process includes the data invalidation parameter restoration step and the steps in the data invalidation process, so as to obtain target data invalidation parameters; and
a fourth executing unit, configured to execute the steps in the data invalidation process according to the target data invalidation parameters.

In an exemplary embodiment, the third execution unit is configured to:
acquire data invalidation parameters of the cache partition from the cache partition service end of the cache partition; and
in cases where the data invalidation parameters of the cache partition service end of the cache partition are acquired, determine the data invalidation parameters of the cache partition service end as the target data invalidation parameters.

In an exemplary embodiment, the third execution unit is configured to:
send a first reference count to the cache partition service end, wherein the first reference count is a reference count of a number of accelerated volumes stored by the cache partition configuration end;
receive a second reference count returned by the cache partition service end according to the first reference count, wherein the second reference count is a reference count of the number of the accelerated volumes stored by the cache partition service end, and the second reference count is sent to the cache partition configuration end in response to the cache partition service end determining that the first reference count is not equal to the second reference count; and
upon reception of the second reference count, determine that the data invalidation parameters of the cache partition service end have been acquired.

In an exemplary embodiment, the first detection module is configured to:
detect whether the cache partition fails during execution of the currently executed operation process;
in cases where it is detected that the cache partition has failed, determine that the operation state indicates that the currently executed operation process cannot be completed; and
in cases where it is detected that the cache partition has not failed, determining that the operation state indicates that the currently executed operation process can be completed.

In an exemplary embodiment, the second detection module is configured to:
determining a target failure causing the currently executed operation process to fail to be completed;
detecting an operation state of a recreation operation performed on the cache partition after the target failure occurs; and
determine the target scenario according to the operation state.

It should be noted that the modules above may be implemented by software or hardware, and the latter may be implemented in the following manner, but is not limited thereto. All the modules above are located in the same processor; or all the modules above are located in different processors in any arbitrary combination manner.

An embodiment of the present application further provides a non-volatile readable storage medium storing a computer program, wherein the computer program is configured to execute, when running, the steps in any one of the described method embodiments.

In an exemplary embodiment, the non-volatile readable storage medium may include, but is not limited to, any medium that can store a computer program, such as a USB flash drive, a Read-Only Memory (ROM), a Random Access Memory (RAM), a removable hard disk, a magnetic disk, or an optical disc.

An embodiment of the present application also provides an electronic device, including a memory and a processor, wherein the memory stores a computer program, and the processor is configured to run the computer program to execute the steps in any one of the method.

In an exemplary embodiment, the electronic device can further include a transmission device and an input/output device, wherein the transmission device is connected to the processor, and the input/output device is connected to the processor.

For optional examples in the present embodiment, reference can be made to the examples described in the described embodiments and exemplary embodiments, and thus they will not be repeated again in the present embodiment.

Obviously, those skilled in the art should understand that the modules or steps in the present application can be implemented by using a general computing device, and they can be integrated in a single computing device, and can also be distributed over a network consisting of a plurality of computing devices. They may be implemented by using executable program codes of the computing devices. Thus, they can be stored in a storage device and executed by the computing devices. Furthermore, in some cases, the shown or described steps may be executed in an order different from that described here, or they can be respectively implemented by individual Integrated Circuit modules, or they can be implemented by making a plurality of the modules or steps into a single Integrated Circuit module. Hence, the present application is not limited to any specific combinations of hardware and software.

The content above merely relates to preferred embodiments of the present application and is not intended to limit the present application. For a person skilled in the art, the present application may have various modifications and variations. Any modifications, equivalent replacements, improvements, etc. made within the principle of the present application shall all belong to the scope of protection of the present application.

1. A method for controlling storage resources in a storage node, comprising:
in a process of deleting a cache partition in a storage node, detecting an operation state of a currently executed operation process, wherein the deletion of the cache partition comprises one or more operation processes, and the one or more operation processes comprise the currently executed operation process;
in cases where it is detected that the operation state indicates that the currently executed operation process fails to be completed, detecting a target scenario which causes the currently executed operation process to fail to be completed;
restoring the currently executed operation process to a target operation process according to the target scenario; and
executing the target operation process, wherein the target operation process is used for continuing to realize the deletion of the cache partition starting from a target partition state of the cache partition which is indicated by the target scenario.

2. The method according to claim 1, wherein restoring the currently executed operation process to a target operation process according to the target scenario comprises:
extracting, from one or more operation steps included in the currently executed operation process, one or more target operation steps allowed to be executed in the target partition state of the cache partition indicated by the target scenario; and
creating the target operation process comprising the one or more target operation steps.

3. The method according to claim 2, wherein extracting, from one or more operation steps included in the currently executed operation process, one or more target operation steps allowed to be executed in the target partition state of the cache partition indicated by the target scenario comprises:
searching the one or more operation steps included in the operation process for operation steps, which are executed after the partition state of the cache partition reaches the target partition state, as candidate operation steps; and
editing the candidate operation steps according to the target partition state to obtain the one or more target operation steps.

4. The method according to claim 3, wherein editing the candidate operation steps according to the target partition state to obtain the one or more target operation steps comprises:
in cases where the target partition state indicates that there is a cache partition, adding an operation parameter restoration step before the candidate operation steps to obtain the one or more target operation steps, wherein the operation parameter restoration step is used for restoring operation parameters used by a cache partition configuration end in the target operation process; and
in response to the target partition state indicating no presence of any cache partition, filtering out operation steps from a candidate list that would be executed in situations with presencing cache partition, thereby obtaining the one or more targeted operation steps.

5. The method according to claim 4, wherein executing the target operation process comprises:
in cases where the one or more target operation steps comprise the operation parameter restoration step and the candidate operation steps, executing the operation parameter restoration step, wherein the operation parameter restoration step is used for acquiring target operation parameters stored by a cache partition service end to serve as the operation parameters used by the cache partition configuration end in the target operation process; and
executing the candidate operation steps using the target operation parameters.

6. The method according to claim 2, wherein creating the target operation process comprising the one or more target operation steps comprises:
acquiring an operation logic of the one or more target operation steps; and
connecting the one or more target operation steps according to the operation logic to obtain the target operation process.

7. The method according to claim 1, wherein restoring the currently executed operation process to a target operation process according to the target scenario comprises:
acquiring a scenario and a reference operation process having a correlation, wherein the reference operation process is used for continuing to realize the deletion of the cache partition in a corresponding scenario; and
searching the scenario and the reference operation process having the correlation, for a reference operation process corresponding to the target scenario as the target operation process.

8. The method according to claim 1, wherein in cases where the currently executed operation process is a data invalidation process, restoring the currently executed operation process to a target operation process according to the target scenario comprises:
in cases where the target scenario indicates that the cache partition is recreated and the recreation is successful, determining that the target operation process comprises a data invalidation parameter restoration step and steps in the data invalidation process, wherein the data invalidation parameter restoration step is used for restoring data invalidation parameters used by a cache partition configuration end in the data invalidation process; and
in cases where the target scenario indicates that the cache partition is recreated but the recreation is not successful, determining that the target operation process comprises a service end notification step and a service configuration processing step, wherein the service end notification step is used for notifying a cache partition service end of the cache partition to cancel a correlation between the cache partition and a volume, and the service configuration processing step is used for clearing a service configuration of the cache partition.

9. The method according to claim 8, wherein executing the target operation process comprises:
in cases where the target operation process comprises the data invalidation parameter restoration step and the steps in the data invalidation process, executing the data invalidation parameter restoration step to obtain target data invalidation parameters; and
executing the steps in the data invalidation process according to the target data invalidation parameters.

10. The method according to claim 9, wherein executing the data invalidation parameter restoration step to obtain target data invalidation parameters comprises:
acquiring data invalidation parameters of the cache partition from the cache partition service end of the cache partition; and
in cases where the data invalidation parameters of the cache partition service end of the cache partition are acquired, determining the data invalidation parameters of the cache partition service end as the target data invalidation parameters.

11. The method according to claim 10, wherein acquiring data invalidation parameters of the cache partition from the cache partition service end of the cache partition comprises:
sending a first reference count to the cache partition service end, wherein the first reference count is a reference count of a number of accelerated volumes stored by the cache partition configuration end;
receiving a second reference count returned by the cache partition service end according to the first reference count, wherein the second reference count is a reference count of the number of the accelerated volumes stored by the cache partition service end, and the second reference count is sent to the cache partition configuration end in response to the cache partition service end determining that the first reference count is not equal to the second reference count; and
upon reception of the second reference count, determining that the data invalidation parameters of the cache partition service end have been acquired.

12. The method according to claim 1, wherein detecting the operation state of a currently executed current operation process comprises:
detecting whether the cache partition fails during execution of the currently executed operation process;
in cases where it is detected that the cache partition has failed, determining that the operation state indicates that the currently executed operation process cannot be completed; and
in cases where it is detected that the cache partition has not failed, determining that the operation state indicates that the currently executed operation process can be completed.

13. The method according to claim 1, wherein detecting the target scenario which causes the currently executed operation process to fail to be completed comprises:
determining a target failure causing the currently executed operation process to fail to be completed;
detecting an operation state of a recreation operation performed on the cache partition after the target failure occurs; and
determining the target scenario according to the operation state.

14. A storage node, comprising a cache partition configuration end and a cache partition service end, wherein
the cache partition configuration end is configured to detect, in a process of deleting a cache partition in a storage node, an operation state of a currently executed current operation process, wherein the deletion of the cache partition comprises one or more operation processes, and the one or more operation processes comprise the currently executed operation process; in cases where it is detected that the operation state indicates that the currently executed operation process fails to be completed, detect a target scenario which causes the currently executed operation process to fail to be completed; restore the currently executed operation process to a target operation process according to the target scenario; and execute a target operation process, wherein the target operation process is used for continuing to realize the deletion of the cache partition starting from a target partition state of the cache partition which is indicated by the target scenario; and
the cache partition service end is configured to execute, in respond to the cache partition configuration end executes the target operation process, an instruction delivered by the cache partition configuration end.

15. The storage node according to claim 14, wherein
the cache partition configuration end is configured to execute an operation parameter restoration step under a condition that a target operation process comprises the operation parameter restoration step, wherein the operation parameter restoration step is used for acquiring a target operation parameter saved by the cache partition service end as the operation parameter used by the cache partition configuration end in the target operation process; continue executing the target operation process using the target operation parameters; and
the cache partition service end is configured to provide the target operation parameters for the cache partition configuration end.

16. The storage node according to claim 14, wherein in cases where the currently executed operation process is a data invalidation process:
the cache partition configuration terminal is configured to determine, in cases where the target scenario indicates that the cache partition is recreated and the recreation is successful, that the target operation process comprises a data invalidation parameter restoration step and steps in the data invalidation process, wherein the data invalidation parameter restoration step is used for restoring data invalidation parameters used by the cache partition configuration end in the data invalidation process; execute the data invalidation parameter restoration step to obtain target data invalidation parameters; execute the steps in the data invalidation process according to the target data invalidation parameters;
the cache partition service end is configured to provide the target data invalidation parameters for the cache partition configuration end.

17. The storage node according to claim 16, wherein
the cache partition configuration end is configured to send a first reference count to the cache partition service end, wherein the first reference count is a reference count of a number of accelerated volumes stored by the cache partition configuration end; receive a second reference count returned by the cache partition service end according to the first reference count, wherein the second reference count is a reference count of the number of accelerated volumes stored by the cache partition service end; upon reception of the second reference count, determine the second reference count as the target data invalidation parameter;
the cache partition service end is configured to receive the first reference count sent by the cache partition configuration end; determine whether the first reference count equals the second reference count; and in response to determining that the first reference count is not equal to the second reference count, send the second reference count to the cache partition configuration end.

18. (canceled)

19. A non-volatile readable storage medium, storing a computer program, wherein the computer program, when executed by a processor, implements the following operations:
in a process of deleting a cache partition in a storage node, detecting an operation state of a currently executed operation process, wherein the deletion of the cache partition comprises one or more operation processes, and the one or more operation processes comprise the currently executed operation process;
in cases where it is detected that the operation state indicates that the currently executed operation process fails to be completed, detecting a target scenario which causes the currently executed operation process to fail to be completed;
restoring the currently executed operation process to a target operation process according to the target scenario; and
executing the target operation process, wherein the target operation process is used for continuing to realize the deletion of the cache partition starting from a target partition state of the cache partition which is indicated by the target scenario.

20. (canceled)

21. The method according to claim 1, comprising:
executing a next operation process of the currently executed operation process among the one or more operation processes when the target operation process has been completed.

22. The storage node according to claim 14, wherein
the cache partition configuration end is further configured to acquire a scenario and a reference operation process having a correlation, wherein the reference operation process is used for continuing to realize the deletion of the cache partitions in a corresponding scenario; and search, from the scenario and the reference operation process having the correlation, for a reference operation process corresponding to the target scenario as the target operation process.
